(19) United States
(12) Patent Application Publication
(10) Pub. No.: US 2007/0117594 A1
(43) Pub. Date: May 24, 2007

(54) Method and system for selective deactivation of a main display

(75) Inventors: Jing Teak Ong, Gelugor (MY); Joseph L. Dvorak, Boca Raton, FL (US); Milay C. Gonzalez, Hialeah Gardens, FL (US); Joseph Patino, Pembroke Pines, FL (US); Charles P. Schultz, North Miami Beach, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/284,628

(22) Filed: Nov. 22, 2005

(51) Int. Cl. H04B 1/38; H04M 1/00

(52) U.S. Cl. 455/566

(57) ABSTRACT

A system (130) and method (500) of operating a main display (301) in a radio (300) can monitoring (502) a use characteristic of the radio. Such use characteristics being monitored can include use of an internal speaker or an external speaker, an open angle (303) of the radio, a type of call, a time of day, a user location, a Caller ID, a holster status, a headset status, a cradle status, a network status, a prepaid minute status, a bus status, or a volume level status). The method can further selectively deactivate (504) the main display based on the use characteristic. In one example, the radio can selectively deactivate (508) the display or backlights when the flip portion is opened to answer the incoming call. The main display (or backlight) can also be selectively activated (510) upon a user button selection if a user desires such activation.

### FIELD OF THE INVENTION

This invention relates generally to displays, and more particularly to a method and system for deactivating a display on a portable electronic device.

### BACKGROUND OF THE INVENTION

Mobile communication devices typically rely on rechargeable power sources and therefore use many different schemes to reduce the current drain to enable longer usage time. One of the sources of current drain includes a main display that can display phone books, incoming caller identification information, and other information. Typically, when a cellular phone receives an incoming call, the backlight for a main display will be lit up. In a cellular phone having a flip portion, the main display backlight may only light up when the flip is open or when a flip is open and an incoming call is received. These actions, although useful in some instances to a user, will unnecessarily cause current drain in many other instances.

### SUMMARY OF THE INVENTION

Embodiments in accordance with the present invention can enable a reduction in current drain by selectively deactivating a main display or a backlight for the main display when a measurable use characteristic is used to make a determination that the display or backlight can be turned off.

In a first embodiment of the present invention, a method of operating a main display in a communication device such as a radio can include the steps of monitoring a use characteristic of the radio and selectively deactivating the main display based on the use characteristic. The use characteristic can be among the use of an internal speaker or an external speaker, an open angle of the radio, a type of call, a time of day, a user location, a Caller ID, a holster status, a headset status, a cradle status, a network status, a prepaid minutes status, a bus status, or a volume level status. The radio can selectively transition dynamically from an activated display to a deactivated display or from the activated display to the deactivated upon a change in the use characteristic. In one example the use characteristic can be a status of a position of a flip portion of the radio or an angle or position of the communication device and a status of an incoming call where the display is selectively deactivated when the flip portion is opened to answer the incoming call. The method can further include the step of selectively activating the main display upon a user action such as button selection. The method can include monitoring a user's habits in turning off the main display during a particular use characteristic and prompting the user to offer to automatically turn off the main display when the particular use characteristic occurs.

In a second embodiment of the present invention, a user interface on a radio can include a main display on the communication device or radio and a processor coupled to the display. The processor can be programmed to monitor a use characteristic of the radio and selectively deactivate the main display based on the use characteristic. The use characteristic can be selected from use of an internal speaker or an external speaker, an open angle of the radio, a type of call, a time of day, a user location, a Caller ID, a holster status, a headset status, a cradle status, a network status, a prepaid minute status, a bus status, or a volume level status. The radio can selectively transition from an activated display to a deactivated display dynamically or vice-versa upon a change in the use characteristic. In one example, the use characteristic can be a status of a position of a flip portion of the communication device or of an angle or position (e.g., upright, sideways, etc.) of the communication device and a status of an incoming call where the radio can deactivate the main display upon the opening of the flip portion to answer the incoming call. The user interface further comprises at least one button and the radio is further programmed to selectively activate the main display after deactivation upon a user button selection. The processor can also be programmed to monitor a user's habits in turning off the main display during a particular use characteristic and prompt the user to automatically turn off the main display when the particular use characteristic occurs. Note, monitoring the user's habits can include recording or storing of the user habit information.

In a third embodiment of the present invention, a wireless communication device can include a main display, a transceiver, and a processor coupled to the display and the transceiver. The processor can be programmed to monitor a use characteristic of the wireless communication device and selectively deactivate the main display based on the use characteristic. As previously mentioned, the use characteristic can be selected from use of an internal speaker or an external speaker, an open angle of the wireless communication device, a type of call, a time of day, a user location, a Caller ID, a holster status, a headset status, a cradle status, a network status, a prepaid minute status, a bus status, or a volume level status. The wireless communication device can selectively transition from an activated display to a deactivated display dynamically (or vice-versa) upon a change in the use characteristic. In one example, the use characteristic can be a status of a flip position of a flip portion of the wireless communication device or an angle or position of the wireless communication device and a status of an incoming call where the wireless communication device deactivates the main display upon the opening of the flip portion to answer the incoming call. The communication device can further include a user interface further having at least one button and the wireless communication device can be further programmed to selectively activate the main display after deactivation upon a user action such as a user button selection. Note, it should be understood that “deactivating the display” can mean deactivating the display itself or deactivating a backlight or other lighting function for the display or even lighting function for the keypads or keys that would impact current drain. Note, that although many of the use characteristics illustrated involve a status of a flip, it should be understood that embodiments herein can include other use characteristics that do not necessarily involve a flip status or a clam-style shaped communication device. The examples of flip phones or devices used herein are not meant to limit the types of use characteristics that can be monitored in contemplation of the embodiments herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a wireless communication device in accordance with an embodiment of the present invention.

FIG. 2 is an illustration of an existing communication system using a communication device that has a display and/or backlight that remains on when the flip is opened in response to receiving a call.

FIG. 3 is an illustration of a communication system using a communication device that has a display and/or backlight that selectively remains off or deactivated when the flip is opened in response to receiving a call in accordance with an embodiment of the present invention.

FIG. 4 is an illustration of the wireless communication device of FIG. 3, illustrating how the display or backlight can be selectively turned on by a user after being deactivated in accordance with an embodiment of the present invention.

FIG. 5 is an illustration of a wireless communication device in a holster or a charging cradle that selectively turns off a display or backlight when holstered or cradled for charging in accordance with an embodiment of the present invention.

FIG. 6 is a flow chart illustrating a method of operating a main display in a radio in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

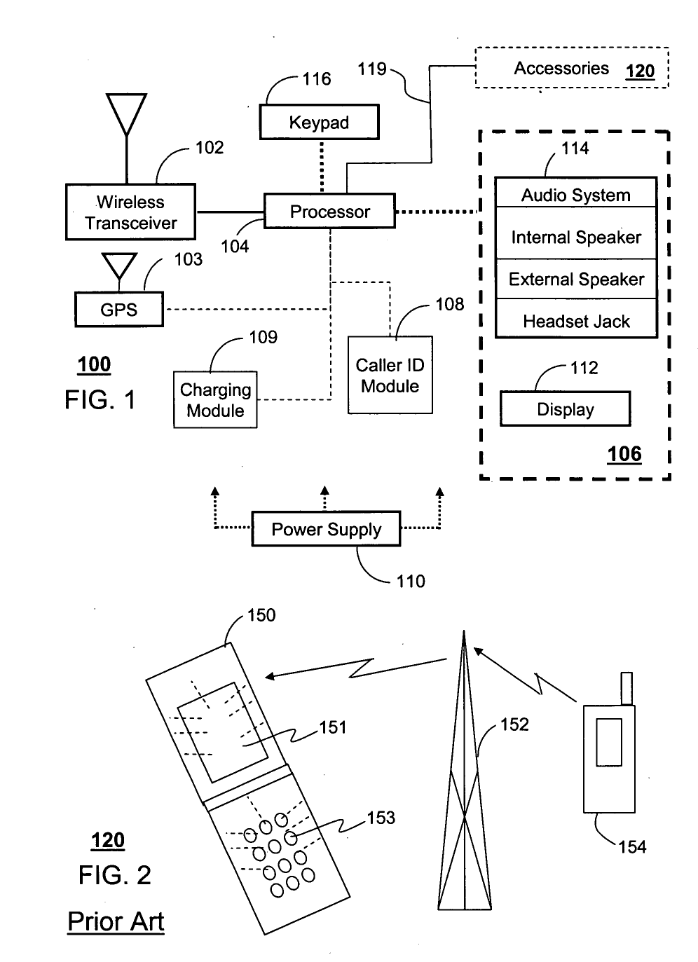

FIG. 1 is a block diagram of a selective call radio (SCR) or wireless communication device 100 in accordance with an embodiment of the present invention. The SCR 100 comprises a wireless transceiver 102, and a processor 104 for controlling operations thereof. The SCR 100 further includes a user interface 106 having an audio system 114 and display 112. The SCR 100 can further include a keypad 116, a caller ID module 108, a location receiver such as a GPS receiver 103, a charging module 109, and a power supply 110. The audio system 114 can include an internal speaker such a speaker used in an earpiece of a cellular phone, an external or high audio speaker such as a speakerphone, and a headset jack or output for use with a separate headset speaker or speakers. The SCR 100 can further include a data bus 119 coupled to the processor 104 for communicating with accessories 120 such as chargers, car kits and other like devices. The wireless transceiver 102 can utilize conventional technology for exchanging wireless messages with a base station 152 (as will be discussed shortly with respect to FIG. 2). The wireless technology can be any conventional wireless technology such as, for example, GSM (Global System for Mobile communication), TDMA (Time Division Multiple Access), or CDMA (Code Division Multiple Access), just to mention a few.

The processor 104 can utilize conventional computing and/or processing technology such as a microprocessor and/or a DSP (Digital Signal Processor). Additionally, the processor 104 can include conventional media such as RAM (Random Access Memory), DRAM (Dynamic RAM), ROM (Read Only Memory), and/or Flash memory for data processing and storage. The audio system 114 utilizes conventional audio technology for intercepting and conveying audible signals to a user of the SCR 100. The display 112 can also utilize conventional technology such as an LCD (Liquid Crystal Display) for conveying images to the user with an optional backlight. The keypad 116 is a conventional input device coupled to the processor 104 for intercepting tactile responses from the user and can also include its own backlight. These responses can be, for instance, tactile responses that represent telephone number dialing for accessing another end user. Generally speaking, the keypad 116 serves to control operations of the SCR 100.

The power supply 110 utilizes conventional energy conversion technology for supply energy to the aforementioned components of the SCR 100. The power supply 110 can be, for instance, a portable battery-operated supply for portable applications of the SCR 100. The processor 104 can be programmed to reduce current drain in a number of ways in accordance with the embodiments of the present invention as will be further discussed below. Further note, the aforementioned embodiments of the SCR 100 can represent a conventional cellular phone, a wireless PDA (Personal Digital Assistant), a handheld gaming device, and derivatives thereof.

Referring to FIG. 2, a conventional communication system 120 is illustrated that includes a wireless communication device 150 having a display or displays 151 and keypad 153 where the communication device 150 is in communication with another wireless communication device 154 via a base station 152. Note, the wireless communication device 150 can include one or more displays (151) and any references to “the main display” or “the display” or “a display” should not necessarily be limited in interpretation to a single display since activation or deactivation of one or more displays are certainly within contemplation of the embodiments herein. The wireless communication device 150 unnecessarily drains current by activating the display(s) 151 upon receiving an incoming communication from wireless device 154.

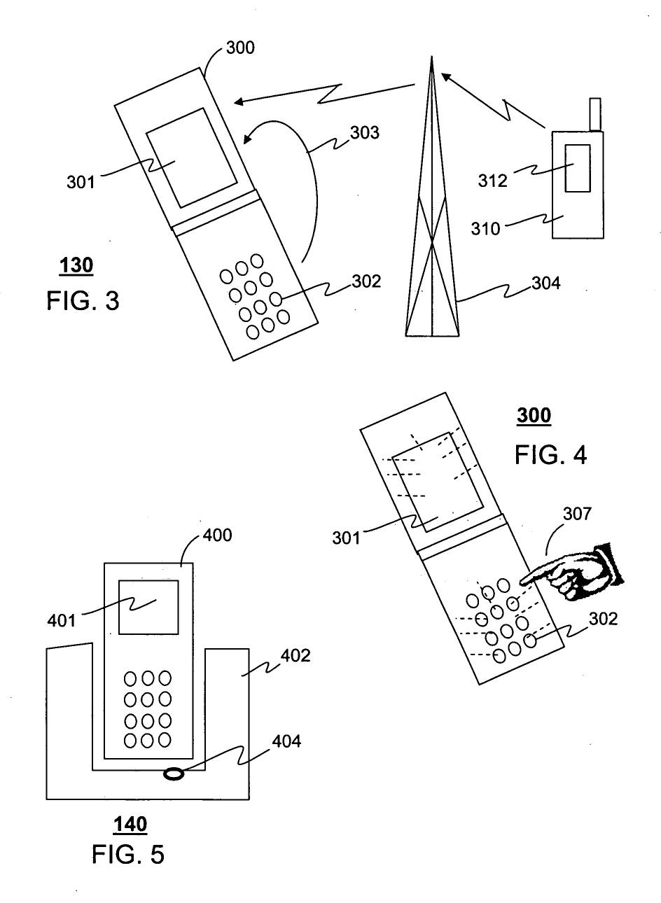

In contrast, a wireless communication system 130 as illustrated in FIG. 3 monitors a radio use characteristic and makes a determination whether to deactivate a display (or displays) 301 or backlight for a wireless communication device 300. If the wireless communication device 300 is a flip or clam-shell style device as shown, the use characteristic can include the determination of receiving an incoming call or message from another wireless device 310 (via a base station 304) and further monitoring an opening angle 303 of a flip portion of the device 300. If the wireless device is a monolith shaped device as illustrated with device 310, then the use characteristic monitored and used to selectively deactivate a display (or displays) 312 might only involve monitoring the receipt of an incoming call or some other use characteristic that can be user or phone manufacturer specified or designed. Such other use characteristics can include, but is not limited to, measurable characteristics such as use of an internal speaker as opposed to an external speaker or an open angle of the radio as illustrated with device 300 or a type of call such as a phone call, instant message, dispatch call, group call, or page or some other type of message or call with a flag or priority associated with it (e.g., emergency, non-emergency). If the use characteristic involves an incoming message and an open angle of a flip, the display(s) 301 or backlights for either the display(s) 301 or keys 302 can remain inactive until a user 307 affirmatively activates the display(s) or backlights by activating a button as illustrated in FIG. 4 or by other user actions such as a voice command or touch screen activation for affirmatively activating the display(s) or backlight.

Another measurable use characteristic can involve monitoring a time of day (or an event on a calendar) such that when an incoming call comes in or a call by the user of the device 300 is made during daylight hours, the display will remain deactivated while nighttime calls (or call before an upcoming event) will activate the display during an incoming or outgoing call. Other use characteristics monitored and used to make a determination to selectively deactivate a display or backlight can include a user location or a recognized Caller ID. Referring to FIG. 5, other measurable use characteristics can monitor how a device is currently used with other devices. For example, a system 140 including a radio 400 having a display 401 and a holster or cradle 402 can determine a holster status or a cradle status using an indicating device 404. The indicating device 404 can simply be a metal contact or other means of informing the radio 400 that it has been cradled or holstered. In most instances, when a radio is cradled (in a battery charger or a car cradle/charger), or holstered (in a radio holster), the display or backlights are not likely required. Another example can include a headset status. If a radio is used with without a headset, then it can be more likely that a backlight would not be needed.

Other factors that can affect the need for using a display or backlight can further include a network or call status, a prepaid minutes status, or a volume level. If a device is roaming or using one particular network technology versus another (3G, iDEN, WiFi, CDMA, GSM), then a logical decision can be made based on this measurable use characteristic. If a prepaid minute status indicates either a low tank, an empty tank or normal, a determination can be made whether to activate or deactivate a display or backlight. A volume level status can also provide such an indication as well. A speakerphone with a low volume may still indicate the use of an active display while a high volume setting may indicate an inactive display. Of course, the use characteristics enumerated herein are examples and should not be limited thereto.

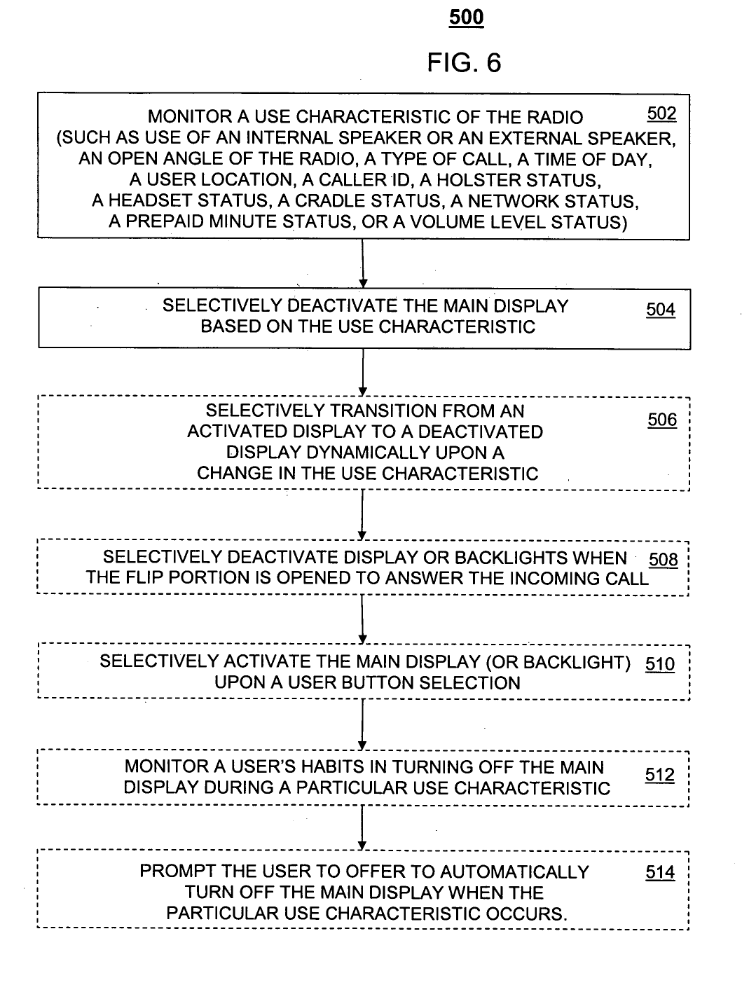

Referring to FIG. 6, a method 500 of operating a main display in a radio can include the step 502 of monitoring a use characteristic of the radio. Such use characteristics being monitored can include use of an internal speaker or an external speaker, an open angle of the radio, a type of call, a time of day, a user location, a Caller ID, a holster status, a headset status, a cradle status, a network status, a prepaid minute status, or a volume level status). The method 500 can further selectively deactivate the main display based on the use characteristic at step 504. Optionally, the radio at step 506 can selectively transition from an activated display to a deactivated display dynamically upon a change in the use characteristic. In one example, the radio can selectively deactivate the display or backlights when the flip portion is opened to answer the incoming call at step 508. At step 510, the main display (or backlight) can be selectively activated upon a user button selection. In another optional aspect, the method 500 can monitor a user's habits in turning off the main display during a particular use characteristic at step 512 and can further prompt the user at step 514 to offer to automatically turn off the main display when the particular use characteristic occurs.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of operating a main display in a communication device, comprising the steps of:
monitoring a use characteristic of the communication device; and
selectively deactivating the main display based on the use characteristic.

2. The method of claim 1, wherein the use characteristic is selected from use of an internal speaker or an external speaker, an open angle of the radio, a type of call, a time of day, a user location, a Caller ID, a holster status, a headset status, a cradle status, a network status, a prepaid minute status, a bus status, or a volume level status.

3. The method of claim 1, wherein the communication device selectively transitions dynamically from an activated display to a deactivated display or from the activated display to the deactivated upon a change in the use characteristic.

4. The method of claim 1, wherein the use characteristic is a status of a flip position of a flip portion of the communication device or an angle or position of the communication device and a status of an incoming call.

5. The method of claim 4, wherein the step of selectively deactivating the main displays occurs upon the opening of the flip portion to answer the incoming call.

6. The method of claim 5, wherein the method further comprises the step of selectively activating the main display upon a user action.

7. The method of claim 1, wherein the method further comprises monitoring a user's habits in turning off the main display during a particular use characteristic and prompting the user to offer to automatically turn off the main display when the particular use characteristic occurs.

8. A user interface on a communication device, comprising:
a main display on the communication device;
a processor coupled to the display, wherein the processor is programmed to:
monitor a use characteristic of the communication device; and
selectively deactivate the main display based on the use characteristic.

9. The user interface of claim 8, wherein the use characteristic is selected from use of an internal speaker or an external speaker, an open angle of the communication device, a type of call, a time of day, a user location, a Caller ID, a holster status, a headset status, a cradle status, a network status, a prepaid minute status, a bus status, or a volume level status.

10. The user interface of claim 8, wherein the communication device selectively transitions dynamically from an activated display to a deactivated display or from the deactivated display to the activated display upon a change in the use characteristic.

11. The user interface of claim 8, wherein the use characteristic is a status of a flip position of a flip portion of the communication device or an angle or position of the communication device and a status of an incoming call.

12. The user interface of claim 11, wherein the communication device deactivates the main display upon the opening of the flip portion to answer the incoming call.

13. The user interface of claim 12, wherein the user interface further comprises at least one button and the communication device is further programmed to selectively activate the main display after deactivation upon a user button selection.

14. The user interface of claim 8, wherein the use interface monitors a user's habits in turning off the main display during a particular use characteristic and prompts the user to offer to automatically turn off the main display when the particular use characteristic occurs.

15. A wireless communication device, comprising:
a main display;
a transceiver; and
a processor coupled to the display and the transceiver, wherein the processor is programmed to:
monitor a use characteristic of the wireless communication device; and
selectively deactivate the main display based on the use characteristic.

16. The wireless communication device of claim 15, wherein the use characteristic is selected from use of an internal speaker or an external speaker, an open angle of the radio, a type of call, a time of day, a user location, a Caller ID, a holster status, a headset status, a cradle status, a network status, a prepaid minute status, a bus status, or a volume level status.

17. The wireless communication device of claim 15, wherein the wireless communication device selectively transitions dynamically from an activated display to a deactivated display or from the deactivated display to the activated display upon a change in the use characteristic.

18. The wireless communication device of claim 16, wherein the use characteristic is a status of a flip position of a flip portion of the wireless communication device or an angle or position of the wireless communication device and a status of an incoming call.

19. The wireless communication device of claim 18, wherein the wireless communication device deactivates the main display upon the opening of the flip portion to answer the incoming call.

20. The wireless communication device of claim 19, wherein wireless communication device further comprise a user interface further having at least one button and the wireless communication device is further programmed to selectively activate the main display after deactivation upon a user button selection.
